(19) United States
(12) Patent Application Publication
(10) Pub. No.: US 2006/0139256 A1
(43) Pub. Date: Jun. 29, 2006

(54) Method and apparatus for driving light-emitting display panel

(75) Inventor: Shinobu Adachi, Yonezawa-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOHOKU PIONEER CORPORATION, Tendo-shi (JP)

(21) Appl. No.: 11/260,246

(22) Filed: Oct. 28, 2005

(30) Foreign Application Priority Data
Dec. 28, 2004 (JP) 2004-378974

(51) Int. Cl. G09G 3/30

(52) U.S. Cl. 345/76

(57) ABSTRACT

A passive matrix light-emitting display panel including, at cross points of a plurality of scan lines and a plurality of data lines which cross each other, light-emitting elements having anode terminals connected to the scan lines and cathode terminals connected to the data lines, respectively, is used. The display panel includes switching units on a scanning drive side to set the scan lines to a scanning selection voltage or a non-scanning selection voltage (ground voltage) and switching units on a data drive side to connect the data lines to ON-drive voltage sources or OFF-drive voltage sources. The ON-drive voltage sources are constituted by sink-type constant current sources which sink ON-drive currents of a light-emitting element in a scanning state from a cathode terminal side of the light-emitting element toward a reference voltage point through the data driver switching units.

### BACKGROUND OF THE INVENTION

1. Field of the Invention

The present invention relates to a drive device and a drive method which can be preferably applied to a passive matrix light-emitting display panel using a capacitive light-emitting element and, more particularly, a drive device and a drive method for a light-emitting display panel which can reduce degrees of generation of shadowing (horizontal crosstalk) and luminance inclination caused by a change in ON rate of the light-emitting devices to a level free from a practical problem.

2. Description of the Related Art

Along with the popularization of a mobile telephone and a personal digital assistant (PDA), a demand for a display panel which can realize a small thickness or a low power consumption increases. As a display panel which satisfies the demand, a conventional liquid crystal panel is applied to a large number of products. On the other hand, in recent years, a display panel using an organic EL (Electro-Luminescence) element which takes advantage of characteristics of a light-emitting display element is practically used. The display panel draws attention as a next-generation display panel alternative to a conventional liquid crystal display panel. This is caused by the background that an organic compound promising preferable light-emitting characteristics is used in a light-emitting layer of an element to achieve high efficiency and long life which are enough to practically use the element.

The organic EL element, for example, as typically showing in FIG. 1A, is basically formed such that a transparent electrode (anode) consisting of, e.g., ITO, a light-emitting function layer, and a metal electrode (cathode) consisting of an aluminum alloy or the like are sequentially stacked on a transparent substrate such as a glass substrate. The light-emitting function layer may be a single light-emitting layer consisting of an organic compound, a two-layer structure consisting of an organic hole transportation layer and an organic light-emitting layer, a three-layer structure consisting of an organic hole transportation layer, an organic light-emitting layer, and an organic electron transportation layer, or a multi-layer structure obtained by inserting a hole injecting layer between the transparent electrode and the hole transportation layer as shown in FIG. 1A or inserting an electron injecting layer between the metal electrode and the electron transportation layer. Light emitted from the light-emitting function layer is guided outside through the transparent electrode and the transparent substrate.

The organic EL element can be electrically replaced with a structure constituted by a light-emitting element having diode characteristics and a parasitic capacitive component coupled to the light-emitting element to each other. It can be said that the organic EL element is a capacitive light-emitting element. When a light-emitting drive voltage is applied to the organic EL element, first, charges corresponding to the electric capacitance of the element flow into the electrode as a displacement current and are accumulated in the electrode. Subsequently, when the voltage exceeds a predetermined voltage (light-emitting threshold voltage=Vth) inherent in the element, a current begins to flow from one electrode (anode side of the diode component) to the light-emitting function layer. It can be understood that light emission occurs with an intensity which is in proportion to the current.

On the other hand, the organic EL element has a current-luminance characteristic which is stable to a change in temperature, and has a voltage-luminance characteristic which is highly dependent on the change in temperature. The organic EL element is considerably deteriorated when an overcurrent flows in the organic EL element, and has reduced emission lifetime. For this reason, the organic EL element is generally driven by a constant current. As a display panel using the organic EL element, a passive drive display panel in which elements are arranged in the form of a matrix has been practically used in part.

FIG. 2 shows a conventional passive matrix display panel and an example of a drive circuit therefor. The drive circuit has a form of cathode-line scanning/anode-line drive. More specifically, m data line (to be also referred to as anode lines hereinafter) A1 to Am are vertically arranged, and n scan line (to be also referred to as cathode lines hereinafter) K1 to Kn are horizontally arranged, and organic EL elements E11 to Emn indicated by parallel couplings between the symbol marks of diodes and capacitors are arranged at cross points (total of m×n points) of the data lines and the scan lines, so that a display panel 1 is constituted.

In the organic EL elements E11 to Emn constituting pixels, one terminals (anode terminals of equivalent diodes of the EL elements) are connected to the anode lines, and the other terminals (cathode terminals of equivalent diodes of the EL elements) are connected to the cathode lines with respect to the cross points of the vertical anode lines A1 to Am and the horizontal cathode lines K1 to Kn. Furthermore, the anode lines A1 to Am are connected to an anode line drive circuit 2 serving as a data drive, and the cathode lines K1 to Kn are connected to a cathode line scanning circuit 3 serving as a scanning driver to drive the anode lines A1 to Am and the cathode lines K1 to Kn.

The anode line drive circuit 2 includes constant current sources I1 to Im serving as ON-drive voltage source operated by using a drive voltage from a drive voltage source VH and drive switches Sa1 to Sam serving as switching means. The drive switches Sa1 to Sam are connected to the constant current sources I1 to Im to supply currents from the constant current sources I1 to Im to the respective organic EL elements E11 to Emn arranged with respect to the cathode lines. The drive switches Sa1 to Sam are designed such that a voltage from a voltage source VAM or a voltage from a reference voltage point (ground voltage GND in this embodiment) serving as an OFF-drive voltage source can be supplied to the organic EL elements E11 to Emn arranged with respect to the cathode lines.

On the other hand, the cathode line scanning circuit 3 includes scan switches Sk1 to Skn serving as switching means are arranged with respect to the cathode lines K1 to Kn. The cathode line scanning circuit 3 is designed such that any one of a reverse bias voltage from a reverse bias voltage source VM mainly used to prevent crosstalk emission and a voltage from the ground voltage GND serving as a reference voltage point can be supplied to a corresponding cathode line.

Control signals are supplied from a light-emission control circuit 4 including a CPU or the like to the anode line drive circuit 2 and the cathode line scanning circuit 3 through a control bus, respectively. On the basis of a video signal to be displayed, switching operations for the scan switches Sk1 to Skn and the drive switches Sa1 to Sam are performed. In this manner, the constant current sources I1 to Im are connected to desired anode lines while setting the cathode lines at the ground voltage in a predetermined cycle on the basis of the video signal to selectively emit the organic EL elements E11 to Emn, so that an image based on the video signal is displayed on the display panel 1.

In the state shown in FIG. 2, the second cathode line K2 is set to the ground voltage to set a scanning state. At this time, reverse bias voltages from the reverse bias voltage source VM are applied to the cathode lines K1 and K3 to Kn in a non-scanning state. In this case, when the forward voltage of the EL element in the scanning light-emitting state is represented by vf, the voltage are set to satisfy a relationship given by: [(forward voltage Vf)−(reverse bias voltage VM)]<(light-emitting threshold voltage Vth). Therefore, the drive device operates such that EL elements connected to cross points driven anode lines and cathode lines which are not selected as scan lines are prevented from performing crosstalk light emission.

The respective organic EL elements arranged on the display panel 1 have parasitic capacitances, respectively. Since the organic EL elements are arranged in the form of a matrix at the cross points of the anode lines and the cathode lines, in a example in which several ten EL elements are connected to one anode line, a synthetic capacity which is several hundred times each parasitic capacity or a capacity more then the synthetic capacity when viewed from the anode line is connected to the anode line as a load capacity. The synthetic capacity conspicuously increases as the size of the matrix increases.

Therefore, at the beginning of an ON scanning period of the EL elements, the currents from the constant current sources I1 to Im are consumed to charge the synthetic capacity, time delay occurs to charge the load capacity until the load capacity sufficiently exceeds a light-emitting threshold voltage (Vth) of the EL elements. Therefore, rising of light emission of the EL elements is disadvantageously delayed (slowed). In particular, as described above, when the constant current sources I1 to Im are used as drive sources of the EL elements, the currents are restricted because the constant current sources are high-impedance output circuits on an operational principle, the rising of light emission of the EL elements is considerably delayed.

This decreases ON-time rates of the EL elements. Therefore, the substantial light-emitting luminances of the EL elements disadvantageously decrease. For this reason, in order to eliminate the delay of rising of light emission of the EL elements caused by the parasitic capacities, in the configuration shown in FIG. 2, an operation of charging EL elements to be turned on is performed by using the reverse bias voltage source VM.

FIGS. 3A to 3E show an ON-drive operation of EL elements including a reset period in which amounts of charge accumulated in the parasitic capacities of the EL elements to be turned on are zero. FIG. 3A shows a scanning synchronous signal. In this example, in synchronism with the scanning synchronous signal, a reset period and a constant current drive period are set.

FIGS. 3B and 3C show voltages applied to an ON line and OFF line of the anode lines connected to the anode driver (anode line drive circuit) 2 in the respective periods. FIGS. 3D and 3E show voltages applied to a scan line and a non-scan line of the cathode lines connected to the cathode driver (cathode line scanning circuit) 3 in the respective periods.

In the reset period shown in FIGS. 3A to 3E, the drive switches Sa1 to Sam serving as switching means included in the anode driver 2 supply voltages from the voltage source VAM to the anode line (ON line) corresponding to the EL elements to be ON-controlled as shown in FIG. 3B. The circuit is controlled such that a ground voltage GND serving as a reference voltage of the circuit is supplied to the anode line (OFF line) corresponding to the EL elements to be turned off as shown in FIG. 3C.

On the other hand, the cathode line scanning driver 3 is designed to apply reverse bias voltages VM to cathode lines (scan lines) to be scanned and cathode lines (non-scan lines) not to be scanned by the scan switches Sk1 to Skn serving as switching means included in the cathode driver 3 as shown in FIGS. 3D and 3E.

In the constant current drive period which is an ON period of the EL element, the drive switches Sa1 to Sam supply constant currents from the constant current sources I1 to Im to anode lines (ON lines) corresponding to EL elements to be turned on as shown in FIG. 3B. The ground voltage GND serving as a reference voltage of the circuit is set to anode lines (OFF lines) corresponding to EL elements to be turned off as shown in FIG. 3C.

On the other hand, the cathode driver 3 in the constant current drive period is controlled such that the scan switches Sk1 to Skn included therein set cathode lines (scan lines) to be scanned to the ground voltage GND as shown in FIG. 3D and apply the reverse bias voltage VM to the cathode lines (non-scan lines) not to be scanned as shown in FIG. 3E.

Immediately after the shift to the constant current drive period, amounts of charges on the parasitic capacities of all the EL elements connected to the ON lines are zero. For this reason, currents transiently flow from the reverse bias voltage source VM into the EL elements to be turned on through EL elements which are not scanned, and the parasitic capacities of the EL elements to be turned on are rapidly charged. As a result, light-emission of the EL elements to be turned on relatively quickly rise.

As described above, the passive drive display device which precharges EL elements to be ON-driven by using a reverse bias voltage is disclosed in the following Japanese Patent Application Laid-Open (JP-A) No. 9-232074 or the like.

In the passive drive display device having the above configuration, it is known that so-called shadowing (horizontal closstalk) in which light-emitting luminances of the EL elements corresponding to scan lines having different ON rates fluctuate depending on the ON rates of the EL elements occurs. FIGS. 4A and 4B and FIGS. 5A and 5B explain a state in which the shadowing occurs.

FIGS. 4A and 4B show a voltage application state to the EL elements in the reset period according to the timing chart shown in FIGS. 3A to 3E and a voltage application state to the EL elements in the constant current drive period according to the timing chart shown in FIG. 3. In FIGS. 4A and 4B, a case in which the ON rate of the EL element is 100%. FIGS. 4A and 4B, for descriptive convenience, show supply states of voltages to the EL elements corresponding to the first, second, and mth anode lines and the first, second and nth cathode lines.

As shown in FIG. 4A, in the reset period, all the scan switches Sk1 to Skn are connected to the VM side, and a reverse bias voltage VM is applied to the cathode lines K1 to Kn. All the drive switches Sa1 to Sam are connected to the VAM side. In this case, the reverse bias voltage VM and the voltage source VAM satisfy a relationship given by: VM=VAM. Therefore, in the reset period shown in FIG. 4A, a voltage difference between both the ends of each of all the EL elements is eliminated, and an amount of charge accumulated in the parasitic capacity of the EL element becomes zero.

On the other hand, in the constant current drive period, as shown in FIG. 4B, a first scan line K1 to be turned on for scanning is set to the ground voltage GND through the scan switch Sk1, and the reverse bias voltage VM is continuously applied to the other scan lines through the scan switches Sk2 to Skn. At this time, all the drive switches Sa1 to Sam are connected to the constant current sources I1 to Im, respectively.

In this manner, ON-drive currents from the constant current sources I1 to Im are supplied to the EL elements connected to the first scan line K1. At this time, a current flowing from the reverse bias voltage source VM to the parasitic capacities of the EL elements transiently flows into the anode side of the EL elements to be turned on through the anode lines, and the parasitic capacities of the EL elements to be turned on are rapidly charged. As a result, rising of light emission of the EL elements to be turned on is relatively quickly performed.

FIGS. 5A and 5B show an example of operation performed when an ON rate of the EL elements decreases. FIGS. 5A and 5B show supply states of voltages to the EL elements in the reset period and the constant current drive period as in FIGS. 4A and 4B. However, in the example shown in FIGS. 5A and 5B, the EL elements corresponding to the first and second anode lines are turned on, and the EL elements corresponding to the mth anode line are turned on. Therefore, it can be said that the ON rate of the EL element is 33% in the scope shown in FIGS. 5A and 5b.

In the reset period, as shown in FIG. 5A, the reverse bias voltage VM is applied to the cathode lines K1 to Kn. The first and second anode lines A1 and A2 are connected to the ground voltage GND, and the mth anode line Am is connected to the VAM side. In this manner, a voltage difference between both the ends of each of the EL elements connected to the mth anode line Am is eliminated, and an amount of charge accumulated in the parasitic capacities of the EL elements connected to the mth anode line Am becomes zero. On the other hand, a reverse bias voltage obtained by the reverse bias voltage VM is applied to the EL elements connected to the first and second anode lines A1 and A2 controlled to be in an OFF state and charged with the polarity shown in FIG. 5A.

Subsequently, in the constant current drive period, as shown in FIG. 5B, for example, the first scan line K1 to be turned on for scanning is set to the ground voltage GND, and the reverse bias voltage VM is applied to the other scan lines. At this time, the first and second anode lines A1 and A2 controlled to be in an OFF state are set to the ground voltage GND, and the mth anode line Am controlled to be in an ON state is connected to the constant current source Im side.

In this manner, an ON-drive current from the constant current source Im is supplied to the EL elements to be turned on connected to the first scan line K1 and the mth anode line Am. At this time, a current flowing from the reverse bias voltage VM into the parasitic capacities of the EL elements which are not scanned transiently flows into the anode side of the EL elements to be turned on through the anode lines to rapidly charge the parasitic capacities of the EL elements to be turned on. As a result, rising of light emission of the EL elements to be turned on is relatively quickly performed.

In this case, the EL elements not to be turned on have been charged by the reverse bias generated by the reverse bias voltage VM and are not changed in state. For this reason, a transient current from the reverse bias VM through the anode lines A1 and A2 not to be turned on rarely flow into the EL elements. As a result, the reverse bias voltages in the cathode lines K2 to Kn in a non-scanning state are rarely dropped, and a current transiently flowing into the anode side of the EL elements to be turned on for scanning through the cathode lines K2 to Kn in a non-scanning state and the anode line Am to be turned on is larger than that in the state shown in FIG. 4B. In this manner, the degree of rising of luminance at the beginning of light emission of the EL elements to be turned on for scanning is conspicuous more than that in the example shown in FIG. 4.

FIG. 6 typically showing an example of shadowing (horizontal crosstalk) caused by the operation described above. In the display pattern shown in FIG. 6, a double-hatched portion “A” indicates a region in which EL elements are set in an OFF state, and single-hatched portions “B” and “C” indicate regions in which EL elements are in an ON state. As indicated as “A” in FIG. 6, for each scan line, when a rate of OFF elements is high (ON rate is low), “bright horizontal crosstalk” in which the portion indicated by “B” emits light brightly more than the portion indicated by “C” occurs.

The example described above is based on a VM reset method which applies a reverse bias voltage of the reverse bias voltage VM to the EL element controlled to be in an OFF state. In contrast to this, in the reset operation mode, in a GND reset method which sets both the ends of EL element controlled in an OFF state at the ground voltage GND, “dark horizontal crosstalk” in which the portion indicated by “B” in FIG. 6 emits light brightly more than the portion indicated by “C” occurs. In addition, the shadowing occurs in various aspects by factors such as a display pattern of the display panel, a time constant, and the like.

Furthermore, since wiring resistances are distributed to the scan lines on the display panel, depending on the distance to a scanning driver, substantial wiring resistances on the scan lines are different from each other. Therefore, as is explained on the basis of FIG. 4, even though the display panel is hard to be relatively influenced by the shadowing because the ON rate of the EL elements is high, so-called luminance inclination where the luminance of an EL element located at a position close to the scanning driver is different from the luminance of an EL element located at a position fur from the scanning driver occurs as a disadvantageous problem.

FIG. 7 is to explain an example in which the luminance inclination occurs. FIG. 7 shows a state in which an ON rate of the EL elements shown in FIG. 4B described above as an equivalent diagram. As shown in FIG. 7, almost equal ON-driver currents ia are supplied from the constant current sources I1 to Im to the EL elements corresponding to the first scan line K1 in a scanning state, respectively.

At this time, a charging operation by the reverse bias voltage VM is performed to the EL elements corresponding to the cathode lines K2 to Kn in a non-scanning state. On the basis of this operation, currents ib, ic, and id flow into the EL elements to be turned on as shown in FIG. 7. Since the currents ib, ic, and id have different values on the basis of electric resistances distributed to the cathode lines, luminance inclination that makes the light-emitting luminances of the EL elements on the first scan line K1 different from each other occurs in consequence.

### SUMMARY OF THE INVENTION

The present invention has been made in consideration of the problems described above, and has as its object to provide a drive device and a drive method for a light-emitting display panel which can reduce shadowing and luminance inclination occurring depending on an ON rate of EL elements as described above to a level at which any problem does not occur in practice.

In a preferable aspect of the drive device according to the present invention made to solve the above problem, there is provided a drive device for a passive matrix light-emitting display panel having a plurality of scan lines and a plurality of data lines which cross each other, and light-emitting elements having such diode characteristics that anode terminals and cathode terminals of the light-emitting elements are connected to the scan lines and the data lines, respectively, including: scanning driver switching means for setting the scan lines to a scanning selection voltage or a non-scanning selection voltage, and data driver switching means for connecting the data lines to an ON-drive voltage source or an OFF-drive voltage source, wherein the ON-drive voltage source is a sink type constant current source which sinks an ON-drive current of a light-emitting element in a scanning state from the cathode terminal side of the light-emitting element toward a reference voltage point through the data driver switching means.

A drive method according to the present invention made to solve the above problems is a drive method for a passive matrix light-emitting display panel having a plurality of scan lines and a plurality of data lines which cross each other, and light-emitting elements having such diode characteristics that anode terminals and cathode terminals of the light-emitting elements are connected to the scan lines and the data lines, respectively, wherein at least a reset period and an ON period of the light-emitting element in one-scanning period of the light-emitting display panel, in the reset period of the light-emitting element, an operation which supplies a scanning selection voltage to a scan line to be scanned, supplies a non-scanning selection voltage to a scan line not to be scanned, and connects all the data lines to an OFF-drive voltage source is executed, in the ON period of the light-emitting element, an operation which supplies a scanning selection voltage to the scan line to be scanned, supplies a non-scanning selection voltage to the scan line not to be scanned, connects a data line to which the light emitting element to be turned on is connected to an ON-drive voltage source, and connects a data line to which the light-emitting element to be turned on is not connected to an OFF-drive voltage source is executed, and the ON-drive voltage source executes a current sink operation which sinks the ON-drive current of the light-emitting element from a cathode terminal side of a light-emitting element in a scanning state toward a reference voltage point.

### BRIEF DESCRIPTION OF THE DRAWINGS

FIG. 1 is a pattern diagram showing a laminate structure of a conventional display panel and a layered structure of a display panel preferably used in the present invention;

FIG. 2 is a circuit diagram showing an example of a conventional passive matrix display panel and a drive circuit therefor;

FIG. 3 is a timing chart for explaining an ON-drive operation in the display panel shown in FIG. 2;

FIGS. 4A and 4B are circuit diagrams for explaining an operation performed when an ON rate of light-emitting elements is high according to the timing chart shown in FIG. 3;

FIGS. 5A and 5B are circuit diagrams for explaining an operation performed when the ON rate of the light-emitting elements is low according to the timing chart;

FIG. 6 is a pattern diagram showing an example in which shadowing occurs;

FIG. 7 is a circuit diagram for explaining an example in which luminance inclination occurs;

FIG. 8 is a circuit diagram showing an embodiment of a drive device according to the present invention;

FIG. 9 is a circuit diagram showing a configuration of a data driver shown in FIG. 8;

FIG. 10 is a timing chart for explaining an ON-drive operation of a display panel driven by the drive device shown in FIG. 8;

FIG. 11 is a circuit diagram showing a state in a reset period set in the configuration shown in FIG. 8;

FIG. 12 is a circuit diagram for explaining an operation performed in the ON period in the configuration shown in FIG. 8 when an ON rate of the light-emitting elements is high;

FIG. 13 is a circuit diagram for explaining an operation performed in the ON period in the configuration shown in FIG. 8 when an ON rate of the light-emitting elements is low; and

FIG. 14 is a circuit diagram for explaining an example in which a setting voltage different from that in the configuration shown in FIG. 8 is used.

### DESCRIPTION OF THE PREFERRED EMBODIMENTS

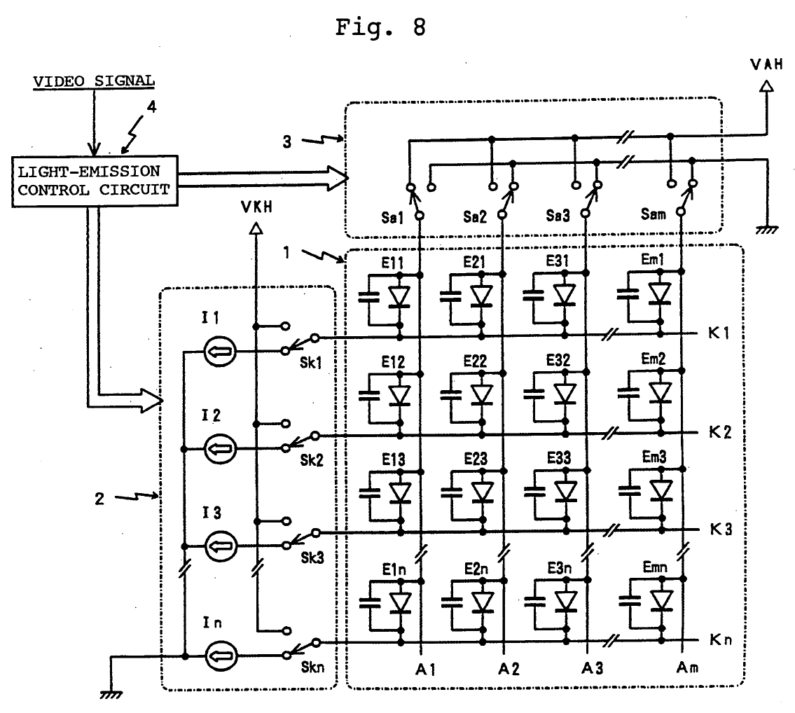

A drive device for a light-emitting display panel according to the present invention will be described below on the basis of an embodiment shown in drawings subsequent to FIG. 8. The same reference numerals as in the embodiment described in FIG. 8 denote parts having the same functions as those of the constituent elements shown in the drawings described above.

In the embodiment shown in FIG. 8, a passive matrix display panel is driven and turned on by a cathode-line drive/anode-line scanning drive method. More specifically, in the example shown in FIG. 8, m scan lines (anode lines) A1 to Am are vertically arranged, and n data line (cathode lines) K1 to Kn are horizontally arranged, and organic EL elements E11 to Emn indicated by parallel couplings between the symbol marks of a diode and a capacitor are arranged at cross points (total of m×n points) of the data lines and the scan lines, so that a display panel 1 is constituted.

In the EL elements E11 to Emn constituting pixels, anode terminals of equivalent diodes of the EL elements are connected to the anode lines, and the cathode terminals of equivalent diodes of the EL elements are connected to the cathode lines with respect to the cross points of the vertical anode lines A1 to Am and the horizontal cathode lines K1 to Kn. Furthermore, the anode lines A1 to Am are connected to an anode line drive circuit 3 serving as a data drive, and the cathode lines K1 to Kn are connected to a cathode line scanning circuit 2 serving as a scanning driver to drive the anode lines A1 to Am and the cathode lines K1 to Kn.

The scanning driver 3 includes scan switches Sa1 to Sam serving as switching means, and is designed to make it possible to set the anode lines A1 to Am to a scanning selection voltage VAH or a non-scanning selection voltage (ground voltage GND in this embodiment. The data driver 2 also includes drive switches Sk1 to Skn as switching means, and is designed to make it possible to set the cathode lines to current-sink type constant current sources I1 to In serving as ON-drive voltage sources or an OFF-drive voltage source VKH.

Control signals are supplied from a light-emission control circuit 4 including a CPU or the like to the anode line drive circuit (scanning driver) 3 and the cathode line drive circuit (data driver) 2 through a control bus, respectively. On the basis of a video signal to be displayed, switching operations for the scan switches Sa1 to San and the drive switches Sk1 to Skm are performed.

In this manner, the scanning selection voltage VAH is sequentially given to the anode lines (scan lines) A1 to Am in a predetermined cycle to sequentially set the anode lines in a scanning state. In synchronous with this, on the basis of the video signal, the current-sink type constant current sources I1 to In are connected to desired cathode lines K1 to Kn, respectively, to selectively give an ON-drive current to the EL elements E11 to Emn, and an image based on the video signal is displayed on the display panel.

The state shown in FIG. 8 shows a case in which the first anode line A1 is set to the scanning selection voltage VAH to set a scanning state. At this time, the current-sink type constant current sources 11 to In are connected to all the cathode lines K1 to Kn, respectively. Therefore, in this state, the anode lines A1 to Am are sequentially scanned, so that all the EL elements on the display panel 1 are controlled to be turned on (ON rate is 100%).

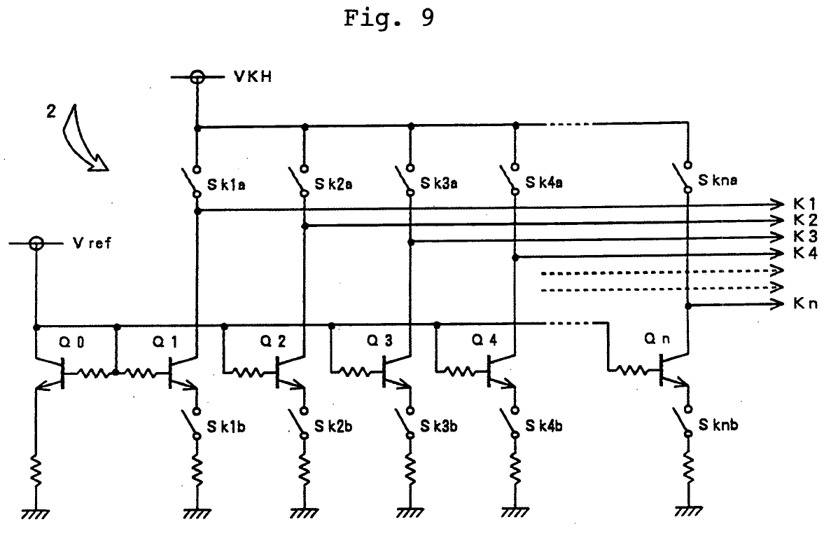

FIG. 9 shows a configuration of the cathode line drive circuits (data driver) 2 in FIG. 8, in particular, the configuration of the current-sink type constant current sources 11 to In as a discrete circuit. In the configuration shown in FIG. 9, the drive switches Sk1 to Skn shown in FIG. 8 are constituted by first analog switches Sk1a to Skna and second analog switches Sk1b to Sknb, respectively. More specifically, the first and second analog switches are complementarily turned on, so that the display panel operates such that the OFF-drive voltage source VKH or current-sink type constant current sources I1 to In constituted by transistors Q1 to Qn are connected to the data lines (cathode lines) K1 to Kn, respectively.

On the other hand, a npn transistor Q0 and the npn transistors Q1 to Qn constitute current mirror circuits each having the transistor Q0 as a current control side. An operation voltage source Vref is supplied to the collector of the transistor Q0, and the collector and the base of the transistor are connected to each other through a resistor. The emitter of the transistor Q0 is connected to a ground GND serving as a reference voltage of a circuit through a current control resistor.

The transistors Q1 to Qn are designed such that the collectors can be connected to the data (cathode lines) K1 to Kn, respectively, and designed to such that the emitters can be connected to the ground voltage GND serving as a reference voltage through the second analog switches Sk1b to Sknb and resistors, respectively. The bases of the transistors Q1 to Qn are connected to the collector of the current control side transistor Q0 through the resistors, respectively.

In this manner, the transistors Q1 to Qn function as current mirror circuits in which currents flowing in the transistors Q1 to Qn are controlled by the value of a current flowing in the current control side transistor Q0. The current mirror circuits operate to sink ON-drive currents from the cathode side of the EL element toward the ground GND point serving as a reference voltage point.

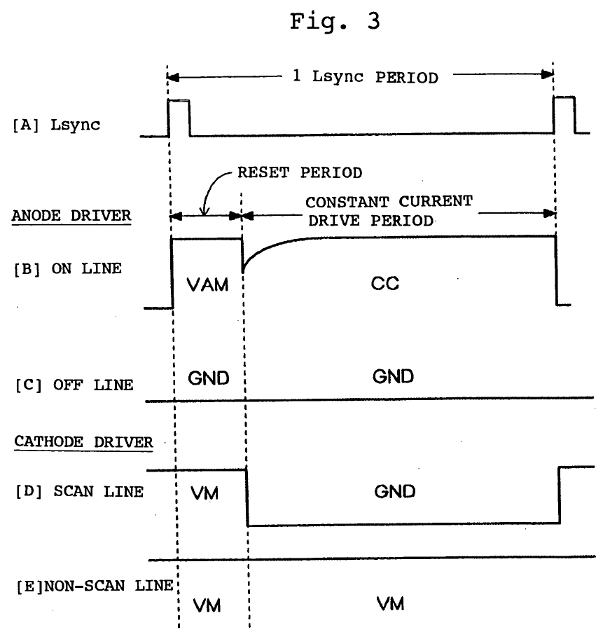

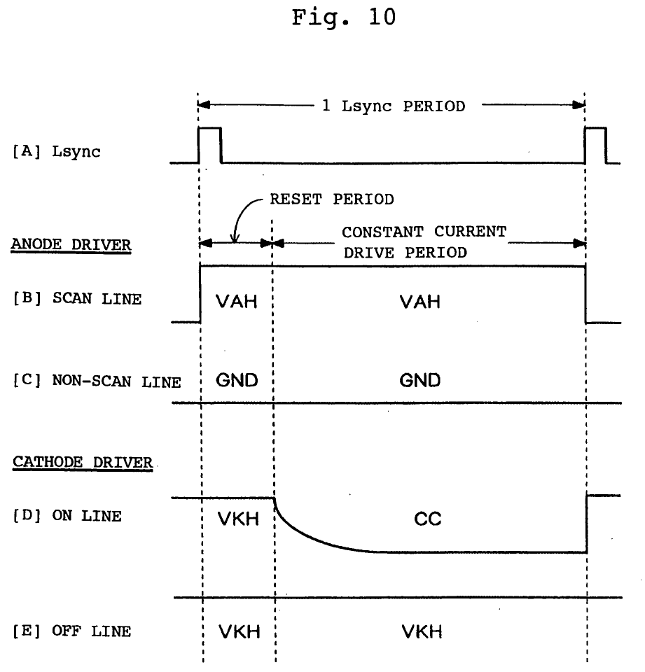

FIG. 10 shows an ON-drive operation of the EL elements including a reset period in which voltages at both the ends of EL elements to be turned on are set to a predetermined voltage to discharge electronic charges accumulated in the parasitic capacities of the EL elements. This operation is described by the same timing chart as in FIG. 3 described above. Symbol A in FIG. 10 indicates a scanning synchronous signal. In this example, the reset period and a constant current drive period serving as an ON period are set in synchronism with the scanning synchronous signal.

Symbols B and C in FIG. 10 indicate voltages applied to a scan line and a non-scan line on an anode line connected to the anode driver (anode line scanning driver) 3 in the periods, respectively. Symbols D and E in FIG. 10 indicate voltages applied to an ON line and an OFF line on a cathode line connected to a cathode driver (cathode line drive circuit) 2 in the periods, respectively.

In the reset period shown in FIG. 10, the scanning driver 3 connects the scanning selection voltage VAH to an anode line (scan line) to be scanned by the scan switches Sa1 to Sam included in the scanning driver 3 as indicated by B in FIG. 10 and sets an anode line (non-scan line) not to be scanned to the ground voltage GND as indicated by C in FIG. 10.

The cathode driver 2 in the reset period supplies a voltage from the OFF-drive voltage source VKH to both the ON line and the OFF line by the drive switches Sk1 to Skn included in the cathode driver 2 as indicated by D and E in FIG. 10.

On the other hand, in the constant current drive period indicated by B in FIG. 10, the anode driver 3 connects an anode line (scan line) to be scanned to the scanning selection voltage VAH by the scan switches Sa1 to Sam included in the anode driver 3 as indicated by B in FIG. 10, and sets an anode line (non-scan line) not to be scanned to the ground voltage GND as indicated by C in FIG. 10.

The cathode driver 2 in the constant current drive period connects an ON line to an ON-drive voltage source, i.e., the current-sink type constant current sources I1 to In constituted by current mirror circuits by the drive switches Sk1 to Skn included in the cathode driver 2 as indicated by D in FIG. 10. The cathode driver 2 operates to supply the OFF-drive voltage source VKH to an OFF line as indicated by E in FIG. 10.

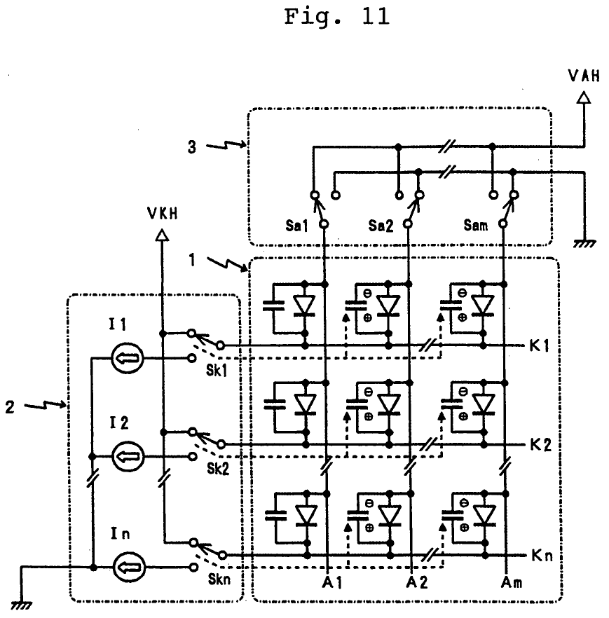

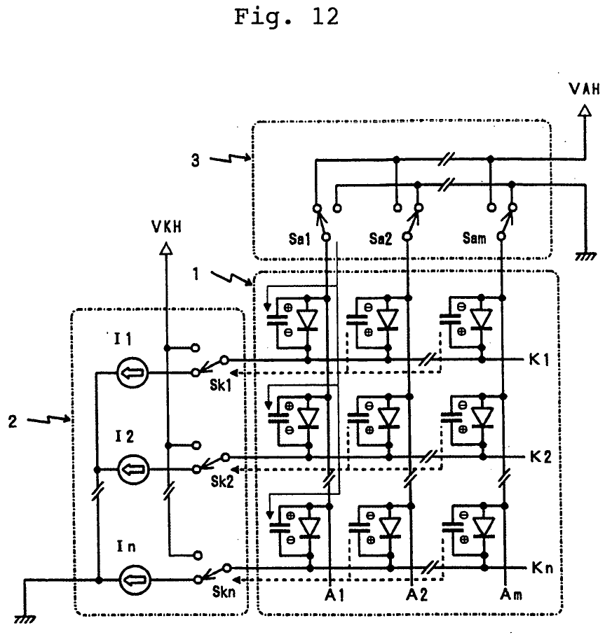

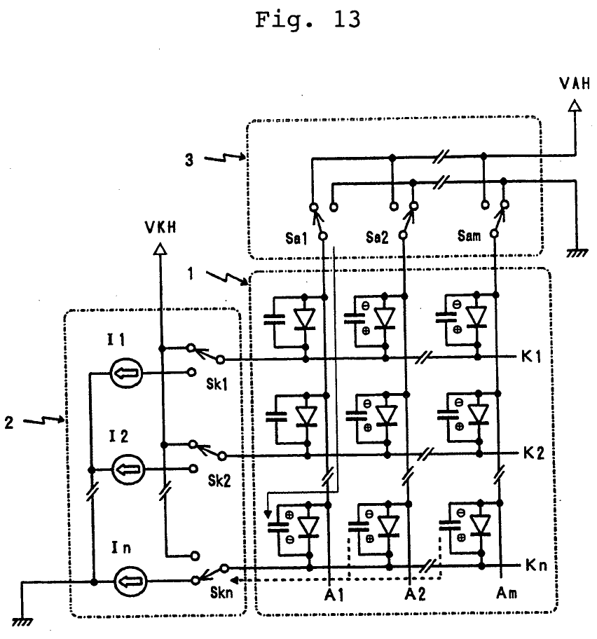

FIGS. 11 to 13 show a voltage application state to EL elements in the reset period and a voltage application state to the EL elements in the constant current drive period according to the timing chart shown in FIG. 10. FIG. 11 shows the voltage application state to the EL elements in the reset period, FIG. 12 shows the voltage application state to the EL elements in the constant current drive period when an ON rate of the EL elements is high (when the ON rate is 100%), and FIG. 13 shows a voltage application state to the EL elements in the constant current drive period when the ON rate of the EL elements is low (when the ON rate is 33%).

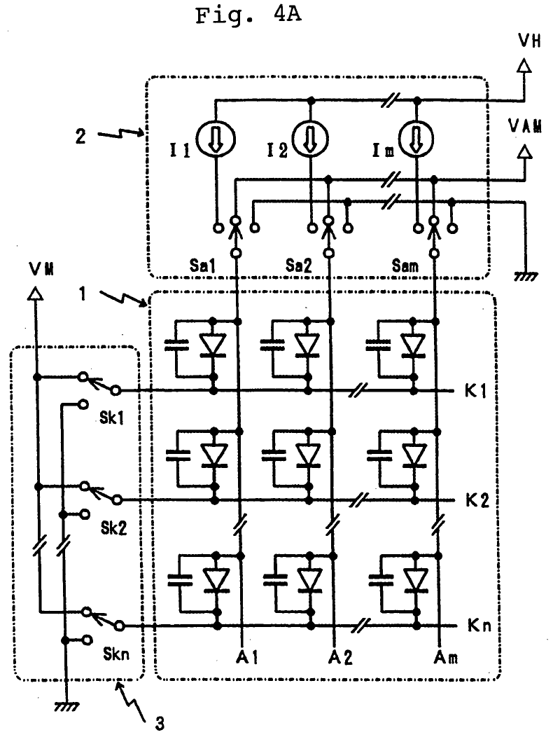

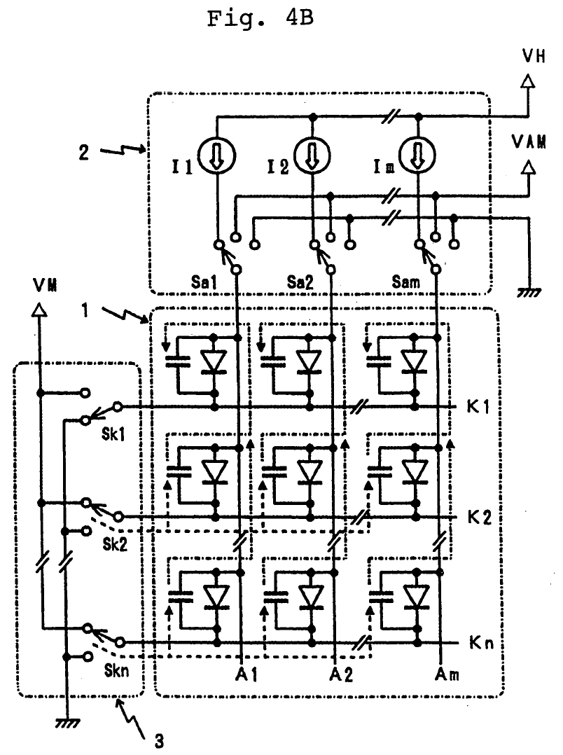

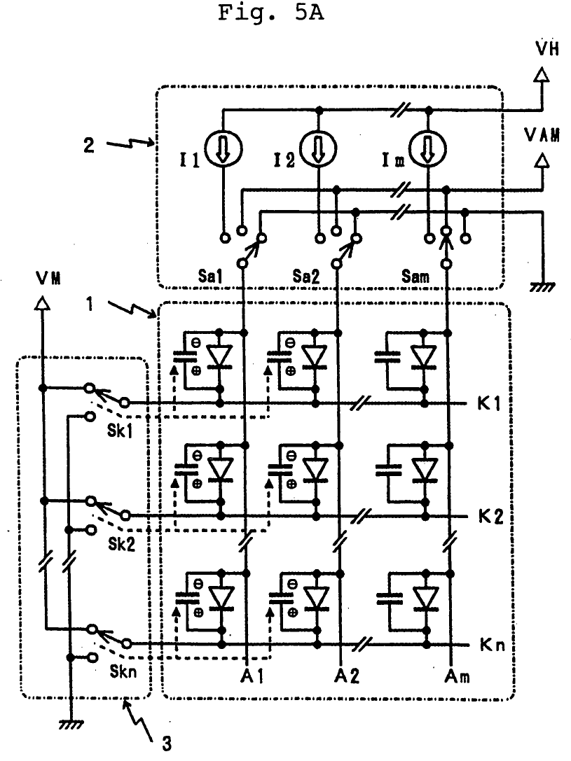

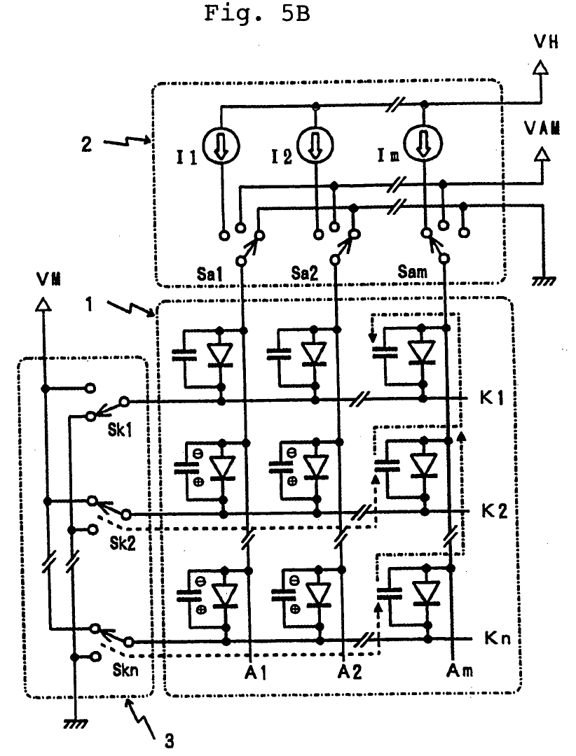

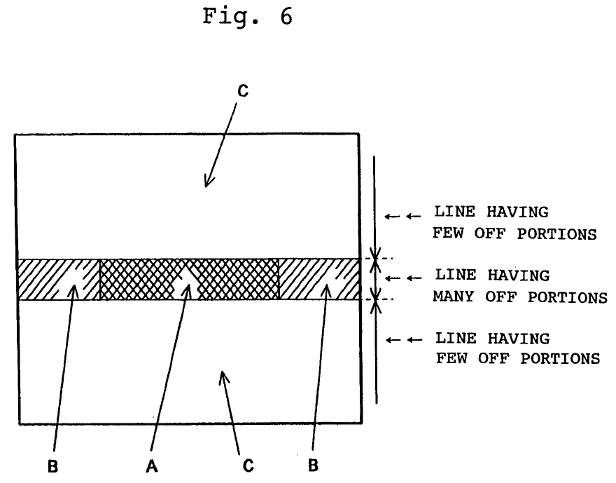

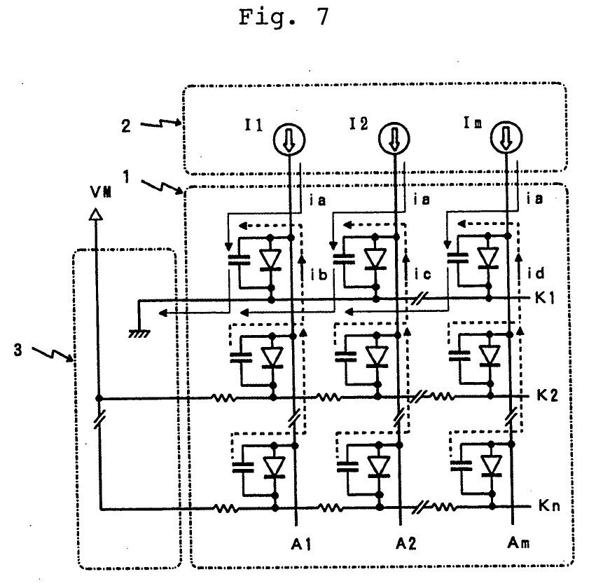

In FIGS. 11 to 13, as in FIGS. 4 and 5 described above, for descriptive convenience, supply states of voltages to the EL elements corresponding to first, second and mth anode lines and first, second, and nth cathode lines are shown.

As shown in FIG. 11, all the drive switches Sk1 to Skn in the cathode driver 2 in the reset period are controlled to be connected to the OFF-drive voltage source VKH side. In the anode driver 3, for example, the first scan line A1 to be turned for scanning is set to the scanning selection voltage VAH through the scan switch Sa1, and the other scan lines are set to the ground voltage GND through the scan switches Sa1 to Sam.

In this case, in the embodiment shown in FIGS. 10 to 13, the OFF-drive voltage source VKH and the scanning selection voltage VAH are set to be almost equal to each other (VKH=VAH). Therefore, in the reset state shown in FIG. 11, the voltages at both the ends of the EL elements corresponding to the first scan line A1 to be turned on for scanning are set to be equal to each other, and a reset operation which discharges electronic charges accumulated in the parasitic capacities of the EL elements is executed.

In the EL elements not to be turned on for scanning, electronic charges having the polarity shown in FIG. 11 are accumulated in the parasitic capacities of the EL elements by the OFF-drive voltage source VKH along a path indicated by a broken line in FIG. 11. The operation in the reset period shown in FIG. 11 is similarly performed regardless of the ON rate of the EL elements.

In the constant current drive period when the ON rate of the EL elements is high, as shown in FIG. 12, the display panel operates such that most of the drive switches Sk1 to Skn in the data driver 2 are connected to the current-sink type constant current sources 11 to In serving as ON-drive voltage sources. The scan switches Sa1 to Sam in the anode driver 3 are set in the same state as that in the reset mode in FIG. 11.

Therefore, the scanning selection voltage VAH is applied to the anode terminals of the EL elements corresponding to the first scan line A1 to be turned on for scanning, and the cathode terminals of the EL elements are subjected to a sink operation of a constant current to the reference voltage (ground voltage GND) side. In this manner, ON-drive currents flow in the EL elements corresponding to the first scan line A1 to be turned on for scanning, and are set in a light-emitting state.

At this time, the non-scan lines A2 to Am are set to a non-scanning selection voltage (ground voltage GND), a current does not transiently sneaks from the non-scan lines A2 to Am into the EL elements to be turned on, and the shadowing can be prevented from occurring. As described above, since a current does not transiently sneaks into the EL elements to be turned on, as described above, a problem in which currents having different values sneak into the EL elements to be turned on due to resistors distributed to the non-scan line to cause luminance inclination can also be solved.

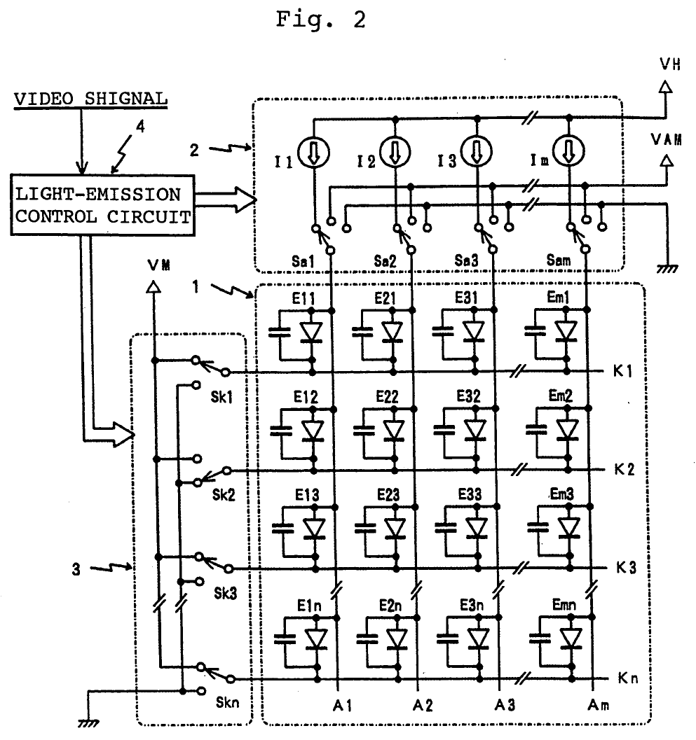

Furthermore, according to the configuration, the EL elements connected to cross points of anode lines which are not selected for scanning and driven cathode lines are interposed between the ground GND voltage serving as the non-scanning selection voltage and a current-sink type constant current source. Therefore, crosstalk light-emission of the EL elements in the cathode-line scanning/anode line drive method as shown in FIG. 2 can be effectively prevented.

FIG. 13 shows an operation in the constant current drive period when EL elements corresponding to a cathode line indicated by Kn are turned on and driven, i.e., when an ON rate of the EL elements is low. In the example shown in FIG. 13, a sink operation of a constant current is executed from the cathode side of the EL elements connected between the anode line A1 in a scanning state and the cathode line Kn serving as an ON line. In this manner, the EL elements are turned on and driven.

In the example shown in FIG. 13, the OFF-drive voltage source VKH is applied to the cathode lines K1 and K2 serving as OFF lines in the constant current drive period, and the voltage of the cathode electrode side of the EL elements corresponding to the OFF line is boosted to the voltage VKH. More specifically, this state is the same as the reset state shown in FIG. 11. Since the scanning selection voltage VAH is almost equal to the voltage of the OFF-drive voltage source VKH, there is no path in which a current flows through the parasitic capacities of the EL elements controlled to be turned off in a scanning state.

At this time, when the non-scan lines A2 to Am are set to the ground voltage GND through the scan switches, a current does not transiently sneak into EL elements to be turned on. Therefore, as shown in FIG. 13, even if an ON rate of the EL elements is low, the shadowing does not occur.

In the embodiment shown in FIGS. 8 to 13, the non-scanning selection voltage is set to the ground voltage GND, the reference voltage of the sink type constant current source serving as an ON drive voltage source is also set to the ground voltage GND, and the scanning selection voltage VAH and the OFF-drive voltage VKH are equal to each other. Under the conditions, as indicated by Equation 1, the scanning selection voltage VAH is desirably set to a value obtained by adding a light-emission threshold voltage (Vth) of the EL element to the reference voltage. In this manner, constant current operations in the current-sink type constant current sources I1 to In functioning as the ON drive voltage sources can be assured.
scanning selection voltage VAH≧(reference voltage+light-emission threshold voltage Vth) Equation 1

Under the conditions, as indicated by Equation 2, the non-scanning selection voltage is desirably set to a voltage which does not exceed a value obtained by adding the light-emission threshold voltage Vth of the light-emitting element to the reference voltage. In this manner, the EL elements set in a non-scanning state can be prevented from being turned on.
non-scanning selection voltage<(reference voltage+light-emission threshold voltage Vth) Equation 2

Furthermore, under the conditions, as indicated by Equation 3, the non-scanning selection voltage is desirably set to a voltage which exceeds a value obtained by subtracting the light-emission threshold voltage Vth of the light-emitting element from the scanning selection voltage VAH. In this manner, the EL elements set in a scanning state and controlled in an OFF state can be prevented from being turned on.
non-scanning selection voltage VKH>(scanning selection voltage VAH−light-emission threshold voltage Vth) Equation 3

In the configuration described above, the example in which the reference voltage in the current-sink type constant current sources I1 to In functioning as ON-drive voltage sources and the non-scanning selection voltage are set to a ground voltage (0 V) is explained. However, the reference voltage and the non-scanning selection voltage may also be different from the ground voltage or different from each other.

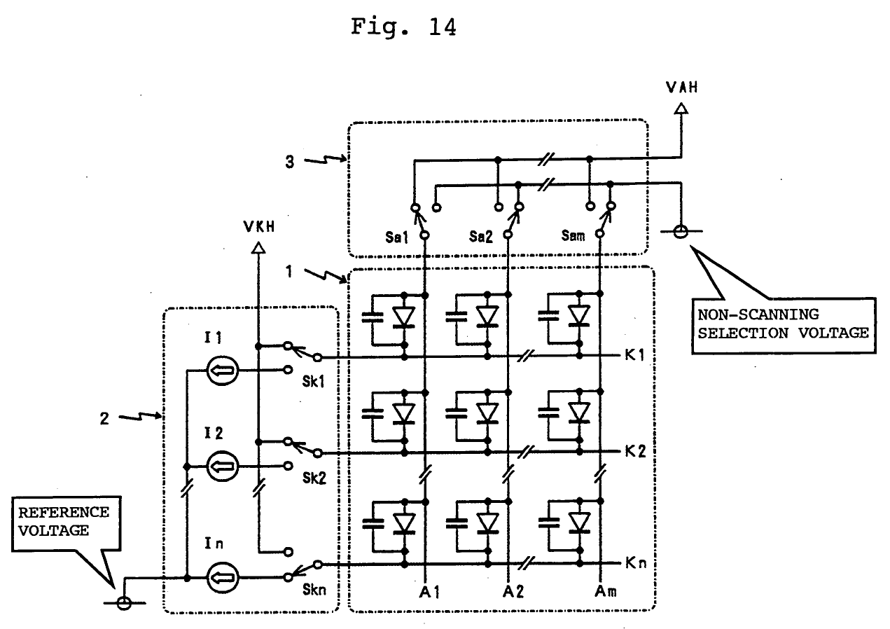

The reference voltage in the constant voltage sources I1 to In shown in FIG. 14 is set to, e.g., +5V, and the non-scanning selection voltage is also set to +5 to assure the relationships given by the Equations 1 to 3 are assured, so that the same operational advantage as described above can be obtained. The reference voltage in the constant current sources I1 to In shown in FIG. 14 is set to −1V, and the non-scanning selection voltage is set to, e.g., +1 V to assure the relationships given by Equations 1 to 3, so that the same operational advantage as described above can be obtained.

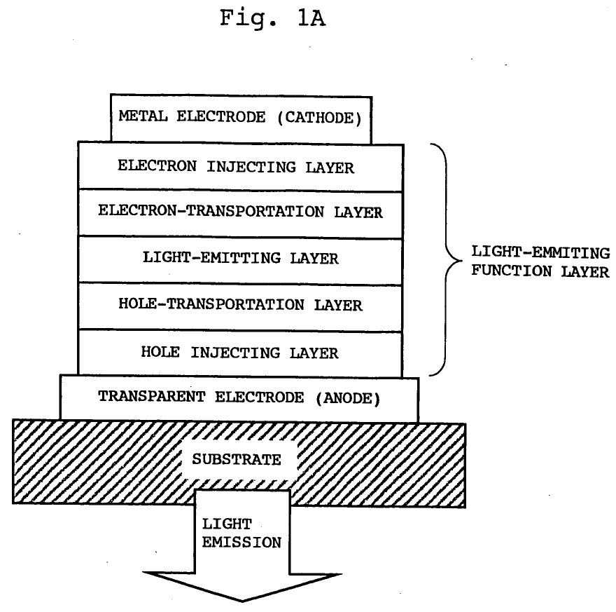

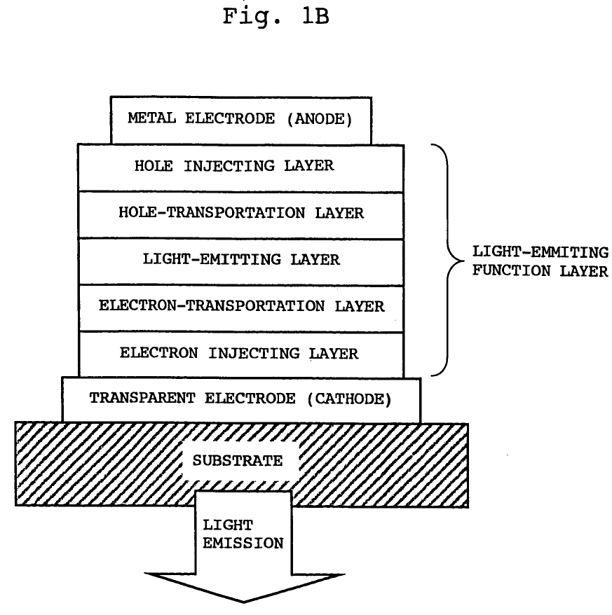

According to the light-emitting display panel 1 having the above configuration, ON drive currents for the EL elements concentratedly flow into an anode line functioning as a scan line, and only an ON-drive current for one EL element flows in cathode lines functioning as drive lines. On the other hand, a transparent electrode which issues light from a light-emitting function layer, consists of ITO or the like, and is formed on the transparent substrate shown in FIG. 1 has a resistivity considerably larger than that of a metal electrode stacked on the light-emitting function layer.

Therefore, when the cathode-line drive/anode-line scanning drive method is employed as in the above configuration, a light-emitting function layer serving as an EL element formed between the transparent electrode consisting of ITO or the like and the metal electrode is desirably designed such that the relationship between the anode and the cathode is opposite to the relationship in the configuration shown in FIG. 1A. More specifically, as shown in FIG. 1B, the laminate configuration serving as the light-emitting function layer is formed in reverse order of the order in FIG. 1A, the ON drive current of the EL elements can be avoided from being concentrated on the transparent electrode consisting of the ITO or the like.

The above explanation is made on the basis of a current actual condition in which the transparent electrode consisting of ITO or the like has a resistivity considerably larger than that of the metal electrode stacked on the light-emitting function layer. When a transparent electrode having a small resistivity is provided, the laminate structure of the light-emitting function layer shown in FIG. 1A can also be preferably employed.

FIG. 1B simply shows the laminate structure as a pattern diagram. However, transparent electrodes serving as data lines formed on the transparent substrate are arranged in a stripe pattern on the transparent substrate, and the light-emitting function layer including at least one light-emitting layer is formed on the transparent electrode depending on a region to emit light, and the plurality of scan lines are stacked on the light-emitting function layer in a stripe pattern in a direction crossing the data lines.

In this case, the light-emitting function layer may employ a configuration in which, in addition to the light-emitting layer, a hole injecting layer is stacked on the scan line side or an electron injecting layer is stacked on the data line side. Furthermore, the light-emitting function layer may employ a configuration in which, in addition to the light-emitting layer, a hole-transportation layer is stacked on the scan line side, or an electron-transportation layer is stacked on the data line side.

The embodiment described above describes an example using organic EL elements as light-emitting elements arranged on a display panel. However, when other capacitive elements are used as the light-emitting elements, the same advantage as described above can be obtained.

What is claimed is:

1. A drive device for a passive matrix light-emitting display panel having a plurality of scan lines and a plurality of data lines which cross each other, and light-emitting elements having such diode characteristics that anode terminals and cathode terminals of the light-emitting elements are connected to the scan lines and the data lines, respectively, comprising:
scanning driver switching means for setting the scan lines to a scanning selection voltage or a non-scanning selection voltage; and data driver switching means for connecting the data lines to an ON-drive voltage source or an OFF-drive voltage source, wherein
the ON-drive voltage source is constituted by a sink type constant current source which sinks an ON-drive current of a light-emitting element in a scanning state from the cathode terminal side of the light-emitting element toward a reference voltage point through the data driver switching means.

2. The drive device for a light-emitting display panel according to claim 1, wherein the scanning selection voltage is set to a voltage not less than a value obtained by adding a light-emission threshold voltage of the light-emitting element to the reference voltage.

3. The drive device for a light-emitting display panel according to claim 1, wherein the non-scanning selection voltage is set to a voltage not more than a voltage obtained by adding a light-emission threshold voltage of the light-emitting element to the reference voltage.

4. The drive device for a light-emitting display panel according to claim 2, wherein the non-scanning selection voltage is set to a voltage not more than a voltage obtained by adding a light-emission threshold voltage of the light-emitting element to the reference voltage.

5. The drive device for a light-emitting display panel according to any one of claims 1 to 4, wherein the voltage of the OFF-drive voltage source is set to a voltage which exceeds a value obtained by subtracting the light-emission threshold voltage of the light-emitting element from the scanning selection voltage.

6. The drive device for a light-emitting display panel according to claim 1, wherein at least one of the reference voltage and the non-scanning selection voltage is set to a ground voltage.

7. The drive device for a light-emitting display panel according to claim 1, wherein the scanning selection voltage and the voltage of the OFF-drive voltage source are set to be equal to each other.

8. The drive device for a light-emitting display panel according to claim 1, wherein the plurality of data lines are arranged in a stripe pattern as transparent electrodes on a transparent substrate, a light-emitting function layer including at least one light-emitting layer is formed on the transparent electrodes depending on a region to emit light, and the plurality of scan lines are stacked on the light-emitting function layer in a stripe pattern in a direction crossing the data lines.

9. The drive device for a light-emitting display panel according to claim 8, wherein, on the light-emitting function layer, in addition to the light-emitting layer, any one of a hole injecting layer and an electron injecting layer is stacked on a corresponding one of the scan line side and the data line side.

10. The drive device for a light-emitting display panel according to claim 8, wherein, on the light-emitting function layer, in addition to the light-emitting layer, any one of a hole-transportation layer and an electron-transportation layer is stacked on a corresponding one of the scan line side and the data line side.

11. A drive method for a passive matrix light-emitting display panel having a plurality of scan lines and a plurality of data lines which cross each other, and light-emitting elements having such diode characteristics that anode terminals and cathode terminals of the light-emitting elements are connected to the scan lines and the data lines, respectively, wherein
at least a reset period and an ON period of the light-emitting element in one-scanning period of the light-emitting display panel,
in the reset period of the light-emitting element, an operation which supplies a scanning selection voltage to a scan line to be scanned, supplies a non-scanning selection voltage to a scan line not to be scanned, and connects all the data lines to an OFF-drive voltage source is executed,
in the ON period of the light-emitting element, an operation which supplies a scanning selection voltage to the scan line to be scanned, supplies a non-scanning selection voltage to the scan line not to be scanned, connects a data line to which the light emitting element to be turned on is connected to an ON-drive voltage source, and connects a data line to which the light-emitting element to be turned on is not connected to an OFF-drive voltage source is executed, and
the ON-drive voltage source executes a current sink operation which sinks the ON-drive current of the light-emitting element from a cathode terminal side of the light-emitting element in a scanning state toward a reference voltage point.

12. The drive method for a light-emitting display panel according to claim 11, wherein the scanning selection voltage is set to a voltage not less than a value obtained by adding a light-emission threshold voltage of the light-emitting element to the reference voltage.

13. The drive method for a light-emitting display panel according to claim 11 or 12, wherein the non-scanning selection voltage is set to a voltage not more than a voltage obtained by adding a light-emission threshold voltage of the light-emitting element to the reference voltage.

14. The drive method for a light-emitting display panel according to claim 11, wherein voltage of the OFF-drive voltage source is set to a voltage which exceeds a value obtained by subtracting the light-emission threshold voltage of the light-emitting element from the scanning selection voltage.

15. The drive method for a light-emitting display panel according to claim 11, wherein at least one of the reference voltage and the non-scanning selection voltage is set to a ground voltage.

16. The drive method for a light-emitting display panel according to claim 11, wherein the scanning selection voltage and the voltage of the OFF-drive voltage source are set to be equal to each other.
